(19) United States
(12) Patent Application Publication
(10) Pub. No.: US 2010/0212336 A1
(43) Pub. Date: Aug. 26, 2010

(54) CONTROL SYSTEM

(75) Inventors: Andrew Chapman, Peterborough (GB); Roderick Andrew Haines, Cambridgeshire (GB)

Correspondence Address: Fleit Gibbons Gutman Bongini & Bianco PL, 21355 EAST DIXIE HIGHWAY, SUITE 115, MIAMI, FL, 33180, US

(73) Assignee: SCOTTISH & NEWCASTLE LIMITED, Edinburgh (UK)

(21) Appl. No.: 12/678,906

(22) PCT Filed: Sep. 17, 2008
(86) PCT No.: PCT/GB08/03152

§ 371 Date: May 10, 2010

(30) Foreign Application Priority Data
Sep. 18, 2007 (GB) 0718176.1

(51) Int. Cl. F25C 1/00; B67D 7/80

(52) U.S. Cl. 62/99; 222/1; 62/178; 62/340; 222/146.6

(57) ABSTRACT

The present invention provides a control system for controlling the ice volume fraction of a circulating ice-containing medium. The control system comprises a freezer apparatus for generating an ice-containing medium, a pump for circulating the ice-containing medium through a flow circuit comprising an outward line, a main line and a return line, and a bypass line connecting the outward line and return line to form a bypass circuit. In use, the time taken for circulating ice-containing medium to pass through the bypass circuit is less than the time taken for circulating ice-containing medium to pass through the flow circuit. The present invention also provides a method for controlling the ice volume fraction of a circulating ice-containing medium using such a control system.

The present application relates to a control system and method for use in a system for circulating an ice-containing medium. In particular, it relates to a control system and method for controlling the ice volume fraction of a circulating ice-containing medium in an ice-circulating system.

Systems for circulating an ice-containing medium are known and are used, for example, for cooling purposes. For example, U.S. Pat. No. 5,139,549 discloses a system for cooling air or water in which aqueous ice slurry is pumped from a freeze exchanger through a coil in a heat exchanger. The air or water is passed over the coil and is cooled by indirect heat exchange with the slush ice in the coil. The heat exchange melts the slush ice and the resulting water is pumped through a return conduit to an ice slurry storage where it is cooled by its passage over an ice bed before returning to the freeze exchanger for re-freezing and re-circulation to the heat exchanger.

In another example described in our co-pending application, GB0704237.7, circulation of slush ice is used to cool a draft beverage prior to dispense. In this system, slush ice is generated using a scraped wall cylinder freezer apparatus and is pumped through the cooling lines of an insulated carrier known as a python. The cooling lines are bundled together with beverage lines in the python and heat exchange between the slush ice in the python cooling lines and beverage in the beverage lines results in cooling of the beverage prior to dispense. The slush ice is then pumped back through the python in a return line to an ice reservoir (which is used as a remote cooler to cool the beverage before it enters the python) before passing back to the freezer apparatus for re-freezing and recirculation.

In both of these examples, the volume fraction of ice in the ice slush is important since it will affect the viscosity of the ice slush and this may affect the flow rate (and therefore cooling capacity) of the slush ice through the conduits/lines. An improved system and method for controlling the ice volume fraction of the ice-containing medium is required.

This control over the volume ice volume fraction of the ice-containing medium becomes even more important when dispense of the ice-containing medium is envisaged. This may be desirable in cases where the ice-containing medium is beverage-based, e.g. if the ice-containing medium is liquid beverage containing frozen particles of beverage. There has recently been interest in providing a draft beverage, e.g. cider, containing frozen particles of beverage to keep the beverage cool in the glass without diluting the beverage. A system for circulating a liquid beverage containing frozen particles of beverage is one way of delivering such a draft beverage and it is necessary to accurately the control the amount of frozen particles to ensure that a consistent product is delivered to the consumer i.e. to ensure that the volume fraction of frozen beverage is substantially constant at the point of dispense.

The present invention aims to provide a system and method for accurately controlling the ice volume fraction in a circulating ice-containing medium.

In a first aspect, the present invention provides a control system for controlling the ice volume fraction of a circulating ice-containing medium, the control system comprising:
a freezer apparatus for generating an ice-containing medium;
a pump for circulating the ice-containing medium through a flow circuit comprising an outward line, a main line and a return line; and
a bypass line connecting the outward line and return line to form a bypass circuit such that, in use, the time taken for circulating ice-containing medium to pass through the bypass circuit is less than the time taken for circulating ice-containing medium to pass through the flow circuit.

The bypass line (which bypasses the main line of the flow circuit) provides a circuit in which circulating ice-containing medium (hereinafter called “ice medium”) spends less time than in the flow circuit (i.e. ice medium passing through the bypass line will return to the freezer apparatus more quickly than ice medium passing through the main line of the flow circuit). Therefore the volume fraction of ice/ice volume fraction (hereinafter called “ice fraction”) in the ice medium can be more tightly controlled in the bypass circuit than in the flow circuit (because there is less opportunity for melting of the ice). Mixing of ice medium (having a tightly controlled ice fraction) from the bypass line with the ice medium in the return line increases the ice fraction of the return line ice medium. This results in the ice medium entering the freezer apparatus having a higher ice fraction than would otherwise be the case thus decreasing the peak load on the freezer apparatus. The bypass line also helps to avoid regions of high or low ice fraction around the main line of the flow circuit because the variation in the ice fraction of the ice medium entering the freezer apparatus and thus exiting the freezer apparatus will be minimised.

For avoidance of doubt, it should be noted that the term “ice” is not intended to be limited to a water ice but encompasses frozen particles of any liquid.

There are several ways to ensure that the time taken for circulating ice medium to pass through the bypass circuit is less than the time taken for circulating ice medium to pass through the flow circuit. For example, if the bypass line and the main line in the flow circuit are of comparable internal diameter (i.d.), the length of the flow circuit main line can be greater than the length of the bypass line. By way of another example, the volume of the bypass circuit could be less than the volume of the flow circuit. For example, the bypass circuit could have a volume of around between 0.5 and 5 litres, e.g. a volume of around 2 litres whilst the flow circuit could have a volume of up to around 20 litres.

The bypass line is adapted to ensure that a desired proportion of the flow of the ice medium in the outward line passes into the bypass line. The desired proportion is typically 10-90% of the flow although a flow of 40-70% of the ice medium through the bypass line is preferred. This proportion is controlled by controlling the flow resistance through the bypass line relative to the flow resistance through the flow circuit main line. Typically the flow circuit main line will have a greater resistance to flow of ice medium than the bypass line. Most typically, this greater resistance will be generated as a result of the flow circuit main line having a greater length than the bypass line. Therefore it is often necessary to increase the resistance in the bypass line, for example, so that it is comparable to the resistance of the main line of the flow circuit so that only a proportion of the ice medium flow passes into the bypass line.

Flow resistance in the bypass line can be controlled in a number of ways. For example, the length and/or diameter of the bypass line can be selected to obtain the desired proportion of flow through the bypass line. Alternatively, the bypass line could include a restrictor such as a narrowed portion of line and/or a partially closed ball valve and/or an orifice plate.

Preferably the bypass line connects to a point on the outward line in close proximity to the freezer apparatus to ensure that the ice medium in the bypass line has an ice fraction as close as possible to that exiting the freezer apparatus.

Preferably, the system comprises a source liquid inlet line (hereinafter called “inlet line”) in fluid communication with the return line, the source liquid being used by the freezer apparatus to generate the ice medium.

Preferably, the system further comprises a controller for controlling the operation of the freezer apparatus. The controller may be connected to one or more detection element(s) in the flow circuit and/or bypass circuit and feedback from the detection element(s) can be used to control the freezing operation of the freezing apparatus. The controller may be a PID controller which can increase/decrease the freezing operation of the freezer apparatus proportionally based on the feedback from the detection element(s). Alternatively, the controller may simply allow switching on and off of the freezing operation of the freezer apparatus.

The detection element(s) may include one or more ice fraction sensors, one or more flow rate meters and/or one or more temperature sensors.

Most preferably, the detection element(s) comprise(s) one or more ice fraction sensors (hereinafter called “ice sensor”) located in the outward line and/or the return line and/or the bypass line for detecting the ice fraction in the ice medium, the controller being in communication with the ice sensor(s) for controlling the operation of the freezer apparatus.

The one or more ice sensor(s) is/are used to detect the ice fraction of the ice medium and can provide feedback to the freezer apparatus via the controller to control the freezing operation of the freezer apparatus so that the ice fraction is brought back within the desired limits. For example, if an ice sensor detects that the ice fraction is too low, a signal from the ice sensor to the controller will trigger the controller to signal the freezer apparatus to commence or increase its freezing operation to raise the ice fraction back to the desired level. There may be a time delay between the signal reaching the controller and the controller sending the signal to the freezer apparatus and/or between the freezer apparatus receiving the signal and commencing/increasing or ceasing/decreasing its freezing operation to ensure that the change in the freezing operation takes effect on the appropriate portion of ice medium.

The one or more ice sensor(s) may be any sensor capable of converting the amount of ice flowing past a point in the line into an output signal for communication to the controller. The output signal could be a measurable voltage, current or frequency. Preferably the one or more ice sensor(s) is/are an optical sensor such as that described in US2005/0200851. Alternatively a sensor using measurement of temperature, capacity, conductance, calorific value (if appropriate), density, flow rate, pressure, viscosity, inductance, latent heat, ultrasound effects, Doppler effect, infra red absorbance, turbidity, potenziometric or ice filtering measurements can be used.

Preferably, an ice sensor is positioned in the return line before the freezer apparatus. In this way the ice sensor can detect the ice fraction in the ice medium in the return line before it enters the freezer apparatus so that the freezer apparatus receives an early indication (via the controller) of any inappropriate ice fraction so that it can start/stop or adjust its freezing operation to bring the ice fraction back to the desired value.

Preferably there is a delay buffer zone between the ice sensor in the return line and the freezer apparatus. This is to allow sufficient time between a portion of ice medium passing through the ice sensor and it reaching the freezer apparatus so that any change in the freezing operation of the freezer apparatus required as a result of the ice fraction measurement of the portion of ice medium can be applied to the portion as it reaches the freezer apparatus. Without this delay buffer zone, detection of a too low or too high ice fraction by the ice sensor could result in a change in the freezing operation of the freezer apparatus (via the controller) only after some of the portion of ice medium having the low/high ice fraction has already passed through the freezer apparatus without being subjected to the change in freezing operation.

This delay buffer zone can either be achieved by selecting an appropriate length/volume of return line between the ice sensor and the freezer apparatus and/or by providing a mixing chamber e.g. a static in-line mixer between the ice sensor and the freezer apparatus, the volume of the chamber being sufficient to induce the necessary delay.

Preferably, in embodiments having an ice sensor in the return line, the bypass line connects to the return line at a position before the ice sensor. In this way the ice medium from the by-pass line can mix with the ice medium in the return line (thus increasing the ice fraction) before the ice medium reaches the ice sensor. This means that the ice fraction measured by the ice sensor is greater and thus can be measured more accurately. It also means that any change in the freezing operation of the freezer apparatus takes into account the increase in ice fraction generated by mixing of the bypass line ice medium with the ice medium in the return line.

Most preferably, in these embodiments, the inlet line also connects to the return line before the return line ice sensor so that the measurement of the ice fraction by the ice sensor takes into account the reduction in the ice fraction caused by the dilution resulting from the addition of source liquid. It is preferable to minimise the distance between the connection of the inlet line with the return line and the return line ice sensor so that the system responds to the introduction of the source liquid (which will have a zero volume ice fraction) as soon as possible. Most preferably, the inlet line connects to the return line before the bypass line.

In some embodiments, a second ice sensor is located in the outward line or bypass line. This second sensor is preferably provided in addition to the return line ice sensor. This second ice sensor will also be connected to the controller. Whilst the return line ice sensor is used to detect the ice fraction in the ice medium approaching the freezer apparatus, the second (outward/bypass line) ice sensor is used to detect the ice fraction of the ice medium produced by the freezer apparatus. This provides an early indication that the change in freezer operation caused by the feedback from the return line ice sensor remains appropriate. For example, if the return line ice sensor detects a drop in ice fraction in the ice medium and thus causes the freezer apparatus to start/increase its freezing action, the outward/bypass line sensor will detect the resulting increase in ice fraction long before it is detected by the return line ice sensor. This also means that should the ice fraction increase too much as a result of the freezing operation, the increase can be detected by the outward/bypass line ice sensor which can then stop/reduce freezing of the freezer apparatus (via the controller).

In embodiments having an ice fraction sensor in both the outward and return lines, the bypass line may connect to the return line at a position before or after the return line ice sensor. In embodiments where it connects to the return line after the return line ice sensor, the ice fraction measured by the return line ice sensor will not take into account the contribution from the bypass line but this contribution can be calculated e.g. by the controller using the ice fraction value obtained from the outward/bypass line sensor and (optionally) from the flow rate of the ice-containing medium in the bypass line.

The detection element(s) may include one or more flow rate meters in the outward line and/or the main line and/or the bypass line and/or the return line and/or the inlet line. A flow rate meter can be used to provide a safety cut-out feature. If the flow rate drops significantly as a result of icing up of the flow circuit and/or bypass circuit, the flow rate meter can provide a signal to the freezer apparatus (via the controller) to cease freezing.

Preferably, a flow rate meter is provided in the inlet line. An increase in flow rate in the inlet line will result in a decrease in ice fraction in the return line (since the source liquid having zero ice fraction will dilute the ice medium in the return line and may (if warm enough) melt some of the ice). The flow rate meter is in communication with the controller and increased flow rate in the inlet line can be communicated to the freezer apparatus to give advance warning of the need for commencing/increasing freezing to increase the reduced ice fraction. A flow rate meter in the inlet line can also be used to monitor the dispense rate (if applicable) from the flow circuit e.g. from a dispense valve in the main line of the flow circuit.

The inlet line may be connected to a source liquid supply e.g. a reservoir. The source liquid supply is preferably a pressurised supply although it could be a non-pressurised supply with an associated pump. Preferably, a chiller e.g. a flash/trim cooler or a water/ice bath cooler may be provided in the inlet line to cool the source liquid prior to its entry into the return line. This will help reduce the melting of the ice in the ice medium in the return line. Most preferably, the inlet line between the chiller and the return line is cooled by heat exchange with a trace cooling line which can be, for example, fed by ice medium from the flow circuit. This trace cooling of the inlet line helps maintain the low temperature of the source liquid in the inlet line especially in periods where the flow rate in the inlet line is minimal.

The freezer apparatus may be a scraped cylinder slush ice generator. Such a generator includes a refrigeration unit which cools a wetted surface which is continuously scraped to form a two phase mixture of small frozen particles (ice) suspended in liquid medium. The volume fraction of the frozen particles (the ice fraction) can be varied such that the ice medium may be a free-flowing liquid suspending frozen particles or it may have a slush consistency. Preferably, the ice fraction is between 1% and 20%; such a mixture is easily pumpable through the cooling line. However, the volume fraction of frozen particles could be up to 40%.

The pump may be any means of circulating the ice medium. It can be positioned in the flow circuit or the bypass circuit. Preferably it is positioned in the outward line after the freezer apparatus or in the return line before the freezer apparatus. Alternatively, the pump may be integral with the freezer apparatus.

The flow circuit is preferably a cooling circuit i.e. the flow circuit is preferably adapted to allow heat exchange between the ice medium in the main line and a warmer medium (e.g. a liquid such as water or beverage, or air) requiring cooling.

In a second aspect, the present invention provides a beverage dispense system having a control system according to the first aspect.

Preferably, the main line of the flow circuit includes a cooling line connected to the outward line and leading to a beverage dispensation site, and a return cooling line leading from the beverage dispensation site to the return line. The bypass line bypasses the cooling line and return cooling line.

Preferably, the cooling line and return cooling line are housed together in a conduit e.g. an insulated conduit such as that known as a “python”. The conduit may additionally include one or more beverage line(s) extending from a beverage source to the dispensation site. Heat exchange between the ice medium in the cooling/return cooling lines and the beverage in the beverage line(s) results in cooling of the beverage or maintenance of the beverage temperature (and will also result in a decrease in the ice fraction of the ice medium).

Additionally/alternatively, the source liquid itself may be a beverage (e.g. an alcoholic beverage such as beer or cider) and the source liquid supply may be a beverage keg or barrel (which may also supply the beverage line(s)). In this case, the beverage dispensation site includes an ice medium dispense valve for dispensing ice medium.

In a third aspect, the present invention provides a method for controlling the ice volume fraction of a circulating ice-containing medium, the method comprising:
generating an ice-containing medium using a freezer apparatus;
providing a flow circuit comprising an outward line, a main line and a return line;
providing a bypass line connecting the outward line and return line to form a bypass circuit; and
circulating the ice-containing medium around the flow circuit and the bypass circuit using a pump such that the time taken for circulating ice-containing medium to pass through the bypass circuit is less than the time taken for circulating ice containing medium to pass through the flow circuit.

By circulating ice-containing medium (hereinafter called “ice medium”) in a bypass circuit in which the ice medium spends less time than in the flow circuit (so that ice medium passing through the bypass line returns to the freezer apparatus more quickly than ice medium passing through the main line of the flow circuit), the volume fraction of ice (hereinafter called “ice fraction”) in the ice medium can be more tightly controlled in the bypass circuit than in the flow circuit (because there is less opportunity for melting of the ice). Mixing of ice medium (having a tightly controlled ice fraction) from the bypass line with the ice medium in the return line increases the ice fraction of the return line ice medium. This results in the ice medium entering the freezer apparatus having a higher ice fraction than would otherwise be the case thus decreasing the load on the freezer apparatus. Circulating ice medium in the bypass line also helps to avoid regions of high or low ice fraction around the flow circuit because the variation in the ice fraction of the ice medium entering the freezer apparatus and thus exiting the freezer apparatus will be minimised.

When circulating the ice medium through the flow circuit and bypass circuit, a proportion of the flow of the ice medium in the outward line passes into the bypass line. The desired proportion is typically 10-90% of the flow although a flow of 40-70% of the ice medium through the bypass line is preferred. This proportion is controlled by controlling (increasing) the flow resistance through the bypass line relative to the flow resistance through the main line of the flow circuit.

Preferably, the method comprises providing a source liquid inlet line (hereinafter called “inlet line”) in fluid communication with the return line and generating the ice medium from the source liquid.

Preferably, the method further comprises controlling the operation of the freezer apparatus using a controller. The method preferably includes measuring data using one or more detection element(s) in the flow circuit and/or bypass circuit, the detection element(s) being connected to the controller. The method preferably comprises using feedback from the detection element(s) to control the freezing operation of the freezing apparatus. The controller may be a PID controller and the method can involve increasing/decreasing the freezing operation of the freezer apparatus proportionally based on the feedback from the detection element(s). Alternatively, the controller may simply allow switching on and off of the freezing operation of the freezer apparatus.

The method may include measuring the ice fraction using one or more ice fraction sensors as the detection element(s), and/or measuring flow rate using one or more flow rate meters as the detection element(s) and/or measuring ice medium temperature using one or more temperature sensors as the detection element(s).

Preferably, the method comprises measuring the ice fraction of the ice medium using one or more ice fraction sensors (hereinafter called “ice sensor”) located in the outward line and/or the bypass line and/or the return line), and controlling the operation of the freezer apparatus using the controller which is in communication with the ice sensor(s). Most preferably, the method comprises measuring the ice fraction of the ice medium using one or more ice sensors in the return line.

By detecting the ice fraction of the ice medium, it is possible to provide feedback to the freezer apparatus via the controller to control the freezing operation of the freezer apparatus so that the ice fraction is brought back within the desired limits. For example, if an ice sensor detects that the ice fraction is too low, a signal from the ice sensor to the controller will trigger the controller to signal the freezer apparatus to commence or increase its freezing operation to raise the ice fraction back to the desired level.

Preferably, measuring the ice fraction is achieved by obtaining optical measurements on the ice medium.

Preferably the method comprises providing a flow delay between an ice sensor in the return line and the freezer apparatus. This is to allow sufficient time between a portion of ice medium passing through the ice sensor and it reaching the freezer apparatus so that any change in the freezing operation of the freezer apparatus required as a result of the ice fraction measurement of the portion of ice medium can be applied to the portion as it reaches the freezer apparatus. Without this delay, detection of a too low or too high ice fraction by the ice sensor could result in a change in the freezing operation of the freezer apparatus (via the controller) only after some of the portion having the low/high ice fraction has already passed through the freezer apparatus without being subjected to the change in freezing operation.

Some embodiments involve measuring the ice fraction using a second ice sensor located in the outward line or bypass line (preferably in addition measuring the ice fraction using the return line ice sensor). This second ice sensor will also be connected to the controller. Whilst the return line ice sensor is used to detect the ice fraction in the ice medium approaching the freezer apparatus the second (outward/bypass line) ice sensor is used to detect the ice fraction of the ice medium produced by the freezer apparatus. This provides an early indication that the change in freezer operation caused by the feedback from the return line ice sensor remains appropriate. For example, if the return line ice sensor detects a drop in ice fraction in the ice medium and thus causes the freezer apparatus to start/increase its freezing action, the outward/bypass line sensor will detect the resulting increase in ice fraction long before it is detected by the return line ice sensor. This also means that should the ice fraction increase too much as a result of the freezing operation, the increase can be detected by the outward/bypass line ice sensor which can then stop/reduce freezing of the freezer apparatus (via the controller).

The method may include measuring the ice medium/supply liquid flow rate using one or more flow rate meters in the outward line and/or the main line and/or the bypass line and/or the return line and/or the inlet line. A flow rate meter can be used to provide a safety cut-out feature. If the flow rate drops significantly as a result of icing up of the flow circuit and/or bypass circuit, the flow rate meter can provide a signal to the freezer apparatus (via the controller) to cease freezing.

Preferably, the method comprises measuring the source liquid flow rate using a flow rate meter in the inlet line. An increase in flow rate in the inlet line will result in a decrease in ice fraction in the return line (since the source liquid having zero ice fraction will dilute the ice medium in the return line and may (if warm enough) melt some of the ice). The flow rate meter is in communication with the controller and increased flow rate in the inlet line can be communicated to the freezer apparatus to give advance warning of the need for commencing/increasing freezing to increase the reduced ice fraction. A flow rate meter in the inlet line can also be used to monitor the dispense rate (if applicable) from the flow circuit e.g. from a dispense valve in the main line of the flow circuit.

Generating the ice medium can include generating a free-flowing liquid suspending frozen particles or generating an ice medium having a slush consistency. Preferably, the ice fraction is between 1% and 20%; such a mixture is easily pumpable through the cooling line. However, the volume fraction of frozen particles could be up to 40%.

The method preferably comprises allowing heat exchange between the ice medium in the main line of the flow circuit and a warmer medium (e.g. a liquid such as water or beverage, or air) requiring cooling.

In a fourth aspect, the present invention provides a method of cooling a beverage using an ice medium having an ice fraction controlled by a method according to the third aspect, the method comprising allow heat exchange between the beverage and the ice medium.

Preferably, the method includes pumping the ice medium to a beverage dispensation site through a cooling line connected to the outward line and pumping the ice medium back to the return line through a return cooling line, (the cooling line and return cooling line forming the main line of the flow circuit). This method preferably includes pumping a proportion of ice medium through the bypass circuit which bypasses the cooling line and return cooling line.

Preferably, the method involves pumping the ice medium through the cooling line and return cooling line which are housed together in a conduit e.g. an insulated conduit such as that known as a “python”. The method may additionally comprise pumping beverage through one or more beverage line(s) extending from a beverage source to the dispensation site. Heat exchange between the ice medium in the cooling/return cooling lines and the beverage in the beverage line(s) results in cooling of the beverage or maintenance of the beverage temperature (and will also result in a decrease in the ice fraction of the ice medium).

Additionally/alternatively, the source liquid may be a beverage (e.g. an alcoholic beverage such as beer or cider) and the source liquid supply may be a beverage keg or barrel (which may also supply the beverage line(s)). In this case, the method preferably includes dispensing the beverage ice medium from a beverage ice medium dispense valve in the main line of the flow circuit at the dispensation site.

In a fifth aspect, the present invention provides a method of dispensing a beverage ice medium having ice volume fraction controlled by a method according to the third aspect, comprising dispensing the beverage ice medium from a dispense valve in the main line of the flow circuit at a dispensation site.

Preferred embodiments of the present invention will now be described, by way of example only, with reference to the accompanying drawings in which:

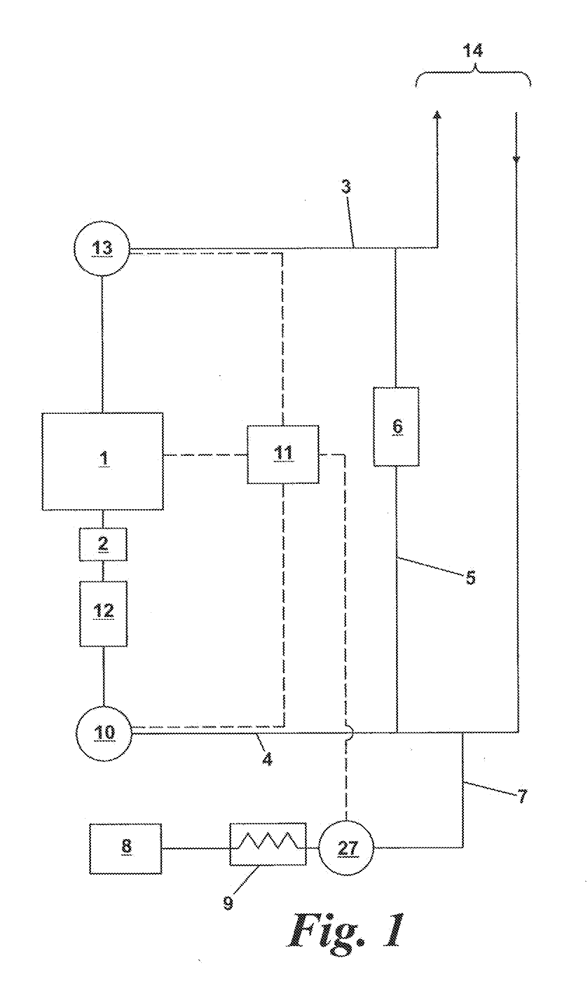

FIG. 1 shows a preferred embodiment of the first aspect of the present invention;

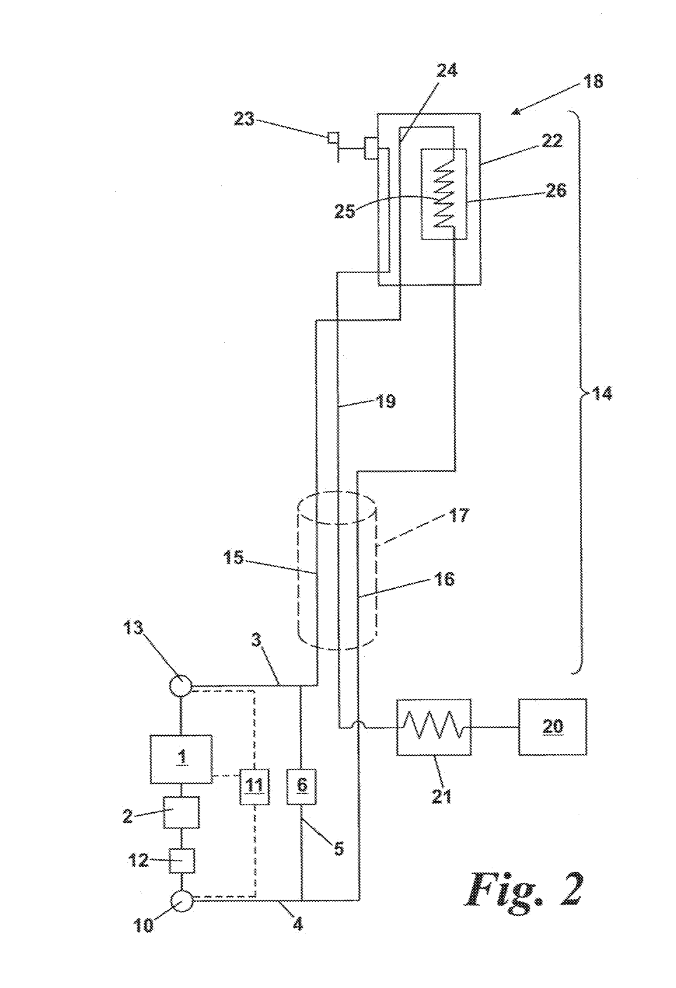

FIG. 2 shows a first preferred embodiment of the second aspect of the present invention; and

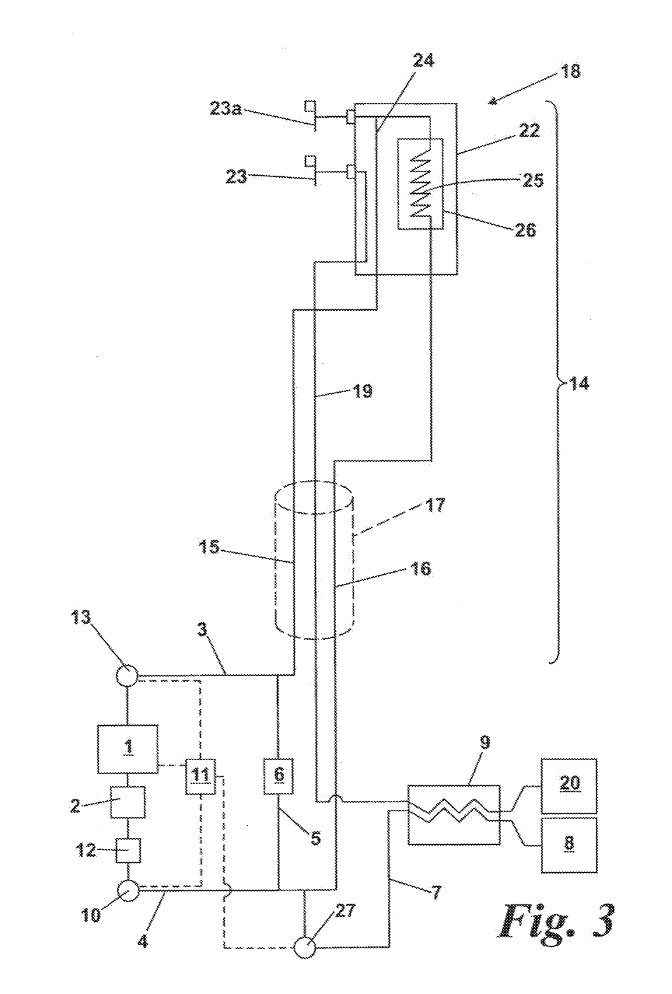

FIG. 3 shows a second preferred embodiment of the second aspect of the present invention.

FIG. 1 shows a control system comprising a freezer apparatus 1, a pump 2, a flow circuit including an outward line 3, a main line 14 (shown incomplete) and a return line 4, and a bypass line 5.

The bypass line 5 connects to the outward line 3 and the return line 4 to form a bypass circuit.

The bypass line includes a restrictor 6 which is a portion of line having a reduced diameter. For example the bypass line may have an o.d. of 0.95 cm (⅜″) and an i.d. of 0.67 cm with a restricted portion having a reduced i.d. (for example, an i.d. of 1-6 mm, preferably around 3 mm).

The purpose of the restrictor is to increase the resistance to the flow of ice medium in the bypass line in order to control the proportion of ice medium flowing through the bypass line. Typically the flow circuit will have a greater resistance to flow of ice medium than the bypass line. Most typically, this greater resistance will be generated as a result of the flow circuit having a greater length than the bypass circuit. Therefore it is often necessary to increase the resistance on the bypass line for example, so that it is comparable to the resistance of the flow circuit so that only a proportion (e.g. 10-90%, preferably 40-70%, most preferably 60%) of the ice medium flow passes into the bypass line.

The freezer apparatus 1 comprises an ice generator which is a scraped wall ice generator. Such a generator includes a refrigeration unit which cools a wetted surface which is continuously scraped to form an ice medium. The volume of the frozen particles (the ice fraction) can be varied such that the ice medium can be a free-flowing liquid suspending frozen particles (e.g. 1 to 20% volume fraction of frozen particles) or it can have a slush consistency (preferably up to 40% volume fraction ice).

The freezer apparatus is adapted to generate microscopic frozen particles. This small particle size is achieved by combination of a high flow rate through the freezer apparatus and scraping the wetted surface at a high frequency by means of a high speed auger motor, typically between 20 rpm and 200 rpm.

The pump 2 is a centrifugal pump such as an MMP4 manufactured by March May. The pump is for pumping the ice medium through the flow circuit/bypass circuit, typically at a flow rate of 2 to 8 litres per minute. As explained above, as a result of the restrictor in the bypass line, the action of the pump will result in a proportion of the ice medium entering the bypass line with the remaining ice medium passing through the main line 14 (shown incomplete) of the flow circuit. The time taken for the ice medium flowing through the bypass line to return to the freezer apparatus will be less than the time taken for the ice medium flowing through the main line to return to the freezer apparatus. This is achieved in this embodiment by providing a main line 14 having the same i.d. as the bypass line 5, but having a longer length than the bypass line and by providing the restrictor 6.

Ice medium from the main line of the flow circuit will mix with ice medium from the bypass line in the return line. Also mixing with the ice medium in the return line will be source liquid entering from the inlet line 7. The inlet line 7 is connected at one end to a source liquid supply 8 and at the other end to the return line at a point before the connection of the bypass line to the return line. The inlet line 7 includes a chiller 9 for cooling the source liquid before it enters the return line 4. A trace cooler (not shown) may also extend from the return line 4 along the path of the inlet line between the chiller 9 and the point of connection to the return line 4 so as to maintain the reduced temperature of the source liquid in the inlet line 7 before it joins the return line 4. This helps to reduce melting of the ice medium (which will lead to a reduction in ice fraction) as the source liquid mixes with the ice medium.

As described above, ice medium from the main line 14 of the flow circuit mixes with source liquid from the inlet line 7 and ice medium from the bypass line 5 in the return line 4. The mixing with the source liquid will lead to a reduction in the ice fraction as a result of the dilution of the ice medium with the source liquid (which will have a zero ice fraction). This reduction in ice fraction will be at least partially compensated for by the subsequent mixing with the ice medium from the bypass line 5. The ice medium from the bypass line 5 will have a greater ice fraction than the ice medium from the main line of the flow circuit because it will have spent less time circulating and thus will have had less time for the ice to melt.

An ice sensor 10 for measuring ice fraction using optical measurements is provided in the return line before the freezer apparatus but after the points of connection of the bypass line 5 and the inlet line 7.

This ice sensor 10 will detect the ice fraction of the ice medium in the return line 4 (which includes the ice medium from the main line 14 of the flow circuit, the ice medium from the bypass line 5 and the source liquid from the inlet line 7). If the ice fraction is above or below the desired ice fraction, the ice sensor sends a signal to a PID controller 11 which in turn sends a signal to the freezer apparatus 1 to cause the freezer apparatus to proportionally reduce or increase its freezing operation in order to ensure that ice medium leaving the freezer apparatus has the desired ice fraction. For example, if the ice sensor 10 detects a low ice fraction (e.g. as a result of a high flow from the inlet line) a signal will be sent to the freezer apparatus 1 (via the controller 11) to cause the freezer to increase it freezing operation.

The return line also includes a delay chamber 12 to provide a delay buffer zone so that there is sufficient time for the change in freezing operation of the freezer apparatus to take effect as the ice medium passes from the ice sensor 10 to the freezer apparatus. This chamber ensures that ice medium having, for example, a low ice fraction is subjected to increased freezing by the freezer apparatus. If there was no delay, the low ice fraction ice medium may pass through the freezer apparatus 1 before the increased freezing operation had had sufficient time to take effect.

An ice sensor 13 for measuring ice fraction using optical measurements is also provided in the outward line after the freezer apparatus.

This ice sensor 13 will detect the ice fraction of the ice medium exiting the freezer apparatus and will act to check that the control of the freezer apparatus by feedback from the return line ice sensor 10 is effective. For example, the return line ice sensor may detect a high ice fraction (e.g. as a result of reduced flow in the inlet line) and this will result in a decrease in the freezing operation of the freezer apparatus. If the outward line sensor 13 detects that the ice fraction of the ice medium exiting the freezer apparatus has dropped too far, it can send a signal to the freezer (via the controller 11) to increase the freezing operation. Without the outward line sensor 13, the excessive drop in ice fraction would eventually be detected by the return line sensor 10 but detection and adjustment of the freezer apparatus operation can be achieved much sooner with the outward line ice sensor.

The inlet line preferably includes a flow meter 27 which is connected to the PID controller 11. This provides feedback to the controller about the rate at which source liquid is entering the return line. A high flow rate can be taken as an early indication that the ice fraction of ice medium in the return line 4 will decrease (as a result of dilution by the source liquid) whereas, conversely, a low/nil flow rate can be taken as an early indication that the ice fraction of ice medium in the return line 4 will rise. This can result in a signal to the freezer apparatus 1 via the controller 11 for the freezer apparatus to increase its freezing operation (when a high flow rate is detected) or decrease its freezing operation (when a low/nil flow rate is detected).

FIG. 2 shows a first preferred embodiment of a beverage dispense system according to the second aspect of the present invention. The beverage dispense system comprises a control system substantially as described for FIG. 1 except where stated. The control system differs in that no inlet line is shown because the system is a closed system i.e. there should be no loss from the system. In practice, the return line 4 is connectable to a source of water/glycol for initial filling of the system and for top-ups where necessary. The control system is preferably located in a remote location e.g. in a cellar along with a beverage supply 20 which is preferably a beverage keg.

The freezer apparatus 1 comprises a scraped wall slush ice generator such as a Taylor 438 generator. Such a generator includes a refrigeration unit which cools a wetted surface (wetted with a 10% solution of glycol) which is continuously scraped to form a two phase mixture of about 40% small ice crystals suspended in a liquid phase (predominantly water).

The pump is a centrifugal pump such as a GP20/18 manufactured by Totton. In the dispense system, the main line 14 of the flow circuit comprises a cooling line 15 and a cooling return line 16 (both having an o.d. of 15 mm) which extend through an insulated carrier 17 to a dispense font 18.

The insulated carrier 17 is of the type commonly known as a “python”. The python comprises a conduit in which runs a beverage line 19, the cooling line 15 and the return line 16. An insulated sheath provides the python with structural integrity and also helps to minimise heat transfer with the surroundings. The python is around 30 metres in length.

The python extends from the remote location to the dispensation site. For the sake of clarity, in FIG. 2, the python is not shown as extending the entire way between the remote location and the dispense font 1. In practice, the python would extend for the whole distance.

The beverage line 19 having an outer diameter of 9.5 mm (⅜″) passes from the beverage supply (e.g. a storage vessel such as a keg or barrel) and through a chiller 21 such as an ice/water bath chiller.

The number of beverage lines in the system can be varied depending on the number of dispense fonts that require connection. In the embodiment shown in FIG. 2, only a single beverage line 19 is shown for the sake of clarity.

After passing through the chiller 21, the beverage line continues through the python to the dispense font 18.

The dispense font 18 comprises a housing 22 which is mountable on a bar or similar surface visible to the customer and on which a dispense tap 23 is mounted. The dispense tap 23 is connected to the beverage line 19. The dispense font 18 is further provided with a cooling loop 24 which is formed from the cooling line and which runs within the font housing 22 in close proximity to the beverage line 19 thus allowing heat transfer between the ice medium in the cooling loop 24 and the beverage in the beverage line 19.

There is also a condensation mechanism comprising a coiled condensation line 25 formed from the cooling line and a metal condensation plate 26, the condensation line 25 being in thermal contact with the condensation plate 26. The metal condensation plate 26 is formed on a surface of the font housing 22 which, in use, faces the customer so that a frosted/iced surface is visible to the customer.

In use, the beverage is dispensed from dispense tap 23. The beverage is dispensed by means of a gas-pressurised system (not shown) or alternatively by a pumping mechanism. Beverage is passed from a storage keg (or similar container) along the beverage line 19. The beverage passes through the chiller 21 where it is cooled to a temperature of 5° C. by heat exchange e.g. with the ice/water in the bath.

The beverage flows through the beverage line 19 in the python 17 to the dispense font 18 at the dispensation site. The beverage flows through the beverage line 19 in the dispense font 18 and the low temperature of the beverage in the beverage line 19 is maintained by thermal contact with the cooling loop 24.

The pump 2 operates to pump ice medium from the freezer apparatus 1 through the outward line 3 and cooling line 15 to the cooling loop 24 and coiled condensation line 25 in the dispense font 18 and then back to the freezer apparatus 1 through the cooling return line 9 and return line 4. The flow rate is between 4 and 8 L/min with a head of no more than 18 metres (although this can be increased if the length of the python is increased).

The ice medium pumped through the cooling line 15 including through the cooling loop cools/maintains the low temperature of the beverage as it flows to the dispensation site. The ice medium pumped through the condensation line causes condensation to form and freeze on the condensation plate.

The control systems functions as previously described to ensure that the ice fraction of the ice medium remains substantially constant. This ensures consistent cooling of the beverage by heat exchange with the ice medium in the cooling line 15 and cooling loop 24.

FIG. 3 shows a second preferred embodiment of a beverage dispense system according to the second aspect of the present invention. This embodiment differs from the first embodiment in that the ice medium is a beverage ice medium i.e. the source liquid is a beverage such as an alcoholic beverage e.g. beer or cider and the beverage ice medium is dispensed from an ice medium tap 23a carried on the dispense font 18.

An inlet line 7 is provided which is connected to a source liquid supply 8 which is a beverage keg. A single chiller 9 is provided which is used to cool beverage from the beverage supply 20 before it enters the beverage line 19 and also to cool the beverage source liquid before it enters the return line. It should be noted that the beverage supply and source liquid supply may be a single supply e.g. a single beverage keg.

The freezer apparatus 1 comprises an ice generator which is a scraped wall ice generator. Such a generator includes a refrigeration unit which cools a wetted surface (wetted with beverage ice medium from the return line) which is continuously scraped to release frozen beverage particles. The ice fraction is selected such that the beverage ice medium is a free-flowing liquid suspending frozen particles (e.g. with a 1 to 20% ice fraction of frozen particles.

The freezer apparatus is adapted to generate microscopic frozen particles. This small particle size is achieved by combination of a high flow rate of beverage ice medium through the freezer apparatus and scraping the wetted surface at a high frequency by means of a high speed auger motor, typically between 20 rpm and 200 rpm.

The pump 2 is a centrifugal pump such as an MMP4 manufactured by March May. In any of the disclosed embodiments, the pump could be one or more pumps in series. The pump 2 operates to pump beverage ice medium from the freezer apparatus 1 through the cooling line 15 and cooling loop 24 to the beverage ice medium dispense tap 23a. If the beverage ice medium tap is opened, beverage ice medium can be dispensed from the tap 23a. If the tap is closed, the beverage cooling medium is pumped through the coiled condensation line 25 in the dispense font 18 and then back to the freezer apparatus 1 through the cooling return line 16 and return line 4.

The beverage ice medium pumped through the cooling line 15 including through the cooling loop 24 cools/maintains the low temperature of the beverage as it flows to the dispensation site. The beverage ice medium pumped through the condensation line 25 causes condensation to form on the condensation plate 26.

The beverage ice medium can be dispensed from the beverage ice medium tap 23a into a vessel separate from the vessel into which the beverage is dispensed (from the beverage dispense tap 23). Alternatively, the beverage ice medium is dispensed into the same vessel as the beverage. For example, a vessel may be partially filled e.g. two thirds filled with beverage from the beverage dispense tap and then the glass can be topped up with beverage ice medium from the beverage ice medium tap 8a. In other embodiments, the beverage ice medium may be added to a vessel from the beverage ice medium tap before or at the same time as beverage is added from the beverage dispense tap.

The flow rate meter 27 in the inlet line can be used to monitor the volume of ice medium which is dispensed (since the volume of dispensed ice medium will require replacement from the source liquid supply).

In this embodiment where the beverage ice medium is dispensed, it is especially important to maintain a substantially constant ice fraction in the ice medium because reproducibility/predictability of the dispense is important for customer satisfaction.

The embodiments described above are given by way of illustration only and various modifications will be apparent to the person skilled in the art.

1. A control system for controlling the ice volume fraction of a circulating ice-containing medium, the control system comprising:
a freezer apparatus for generating an ice-containing medium;
a pump for circulating the ice-containing medium through a flow circuit comprising an outward line, a main line and a return line; and
a bypass line connecting the outward line and return line to form a bypass circuit such that, in use, the time taken for circulating ice-containing medium to pass through the bypass circuit is less than the time taken for circulating ice-containing medium to pass through the flow circuit.

2. A control system according to claim 1 wherein the bypass line and the main line in the flow circuit are of comparable internal diameter and the length of the flow circuit main line is greater than the length of the bypass line.

3. A control system according to claim 1 wherein the volume of the bypass line is less than the volume of the flow circuit main line.

4. A control system according to claim 1 wherein the bypass line includes a restrictor.

5. A control system according to claim 1 wherein the bypass line connects to a point on the outward line in close proximity to the freezer apparatus.

6. A control system according to claim 1 wherein the system further comprises a source liquid inlet line in fluid communication with the return line.

7. A control system according to claim 1 wherein the system further comprises a controller for controlling the operation of the freezer apparatus, the controller being connected to one or more detection element(s) in the flow circuit and/or bypass circuit.

8. A control system according to claim 7 wherein the detection element(s) include one or more ice fraction sensors and/or one or more flow rate meters and/or one or more temperature sensors.

9. A control system according to claim 8 wherein the detection element(s) comprise(s) one or more ice fraction sensors located in the outward line and/or the return line and/or the bypass line.

10. A control system according to claim 9 comprising an ice fraction sensor in the

11. A control system according to claim 10 further comprising a delay buffer zone between the ice fraction sensor in the return line and the freezer apparatus.

12. A control system according to claim 10 wherein the bypass line connects to the return line at a position before the ice fraction sensor in the return line.

13. A control system according to claim 8 comprising an ice fraction sensor in the outward line and/or bypass line.

14. A control system according to claim 8 when dependent upon claim 6 comprising a flow rate meter in the source liquid inlet line.

15. A control system according to claim 1 wherein the flow circuit is a cooling circuit.

16. A beverage dispense system comprising a control system as defined in claim 1.

17. A beverage dispense system according to claim 16 comprising an ice-containing medium dispense valve for dispensing ice-containing medium.

18. A method for controlling the ice volume fraction of a circulating ice-containing medium, the method comprising:
generating an ice-containing medium using a freezer apparatus;
providing a flow circuit comprising an outward line, a main line and a return line;
providing a bypass line connecting the outward line and return line to form a bypass circuit; and
circulating the ice-containing medium around the flow circuit and the bypass circuit using a pump such that the time taken for circulating ice-containing medium to pass through the bypass circuit is less than the time taken for circulating ice containing medium to pass through the flow circuit.

19. A method according to claim 18 further comprising measuring data using one or more detection element(s) in the flow circuit and/or bypass circuit, the detection element(s) being connected to a controller.

20. A method according to claim 19 comprising measuring the ice volume fraction of the ice-containing medium using one or more ice fraction sensors, and/or measuring flow rate using one or more flow rate meters and/or measuring ice-containing medium temperature using one or more temperature sensors.

21. A method according to claim 20 comprising measuring the ice volume fraction of the ice-containing medium using one or more ice fraction sensors located in the outward line and/or the bypass line and/or the return line.

22. A method according to claim 21 comprising measuring the ice volume fraction of the ice-containing medium using an ice fraction sensor in the return line.

23. A method according to claim 22 comprising providing a flow delay between the ice fraction sensor in the return line and the freezer apparatus.

24. A method according to claim 20 comprising measuring the ice volume fraction of the ice-containing medium using an ice fraction sensor in the outward line and/or the bypass line.

25. A method according to claim 20 comprising measuring the flow rate of a source liquid in a source liquid inlet line, the source liquid line being connected to the return line.

26. A method according to claim 18 comprising generating an ice-containing medium comprising a free-flowing liquid suspending ice particles or generating an ice-containing medium having a slush consistency.

27. A method according to claim 18 comprising allowing heat exchange between the ice-containing medium in the main line of the flow circuit and a warmer medium requiring cooling.

28. A method of cooling a beverage using an ice-containing medium having an ice volume fraction controlled by a method as defined in claim 18 comprising allow heat exchange between the beverage and the ice-containing medium.

29. A method of dispensing a beverage ice-containing medium having ice volume fraction controlled by a method as defined in claim 18, comprising dispensing the beverage ice-containing medium from a dispense valve at a dispensation site.

30-32. (canceled)
